(19) United States
(12) Patent Application Publication
(10) Pub. No.: US 2026/0251050 A1
(43) Pub. Date: Aug. 27, 2026

(54) Systems and Methods for Downward Drilling Robotic Systems

(71) Applicants: August Robotics Limited, Hong Kong (CN); Black & Decker Inc., New Britain, CT (US)

(72) Inventors: Alexander August Wyatt, Las Vegas, NV (US); Jie Li, Shenzhen (CN); Luming Wang, Shenzhen (CN); Jiancheng Zhang, Shenzhen (CN); Chuan Ding, Shenzhen (CN); Ricardo B. Rodriguez, Fontana, CA (US); Alexander Schickling, Aurora, CO (US)

(73) Assignees: August Robotics Limited, Hong Kong (CN); Black & Decker Inc., New Britain, CT (US)

(21) Appl. No.: 19/548,713

(22) Filed: Feb. 24, 2026

Related U.S. Application Data
(60) Provisional application No. 63/763,192, filed on Feb. 25, 2025.

(51) Int. Cl. E21B 44/00; E21B 17/07; E21B 19/24; E21B 21/01

(52) U.S. Cl. CPC E21B 44/00; E21B 17/07; E21B 19/24; E21B 21/011

(57) ABSTRACT

Systems and methods for downward drilling robotic systems in accordance with embodiment of the invention are illustrated. One embodiment includes a drilling robot. The robot includes an outer casing, a chassis coupled to the outer casing, and a plurality of wheels. The drilling robot further includes at least one drive motor received at least partially in the chassis and configured to rotatably drive the plurality of wheels on a surface, an autonomous control system configured to control movement of the drilling robot along the surface, and a drilling module coupled to the housing that supports a drill for movement along a movement axis transverse to the surface.

### CROSS-REFERENCE TO RELATED APPLICATIONS

This application claims priority to U.S. Application No. 63/763,192, titled “Systems and Methods for Downward Drilling Robotic Systems,” filed Feb. 25, 2025, which is hereby incorporated by reference in its entirety.

### FIELD OF THE INVENTION

The present invention generally relates to artificial intelligence and control systems and, more specifically, the control and management of the operation of drilling robots.

### BACKGROUND

An autonomous control system refers to a system capable of making decisions and performing actions without direct human intervention. These systems rely on sensors, actuators, and algorithms to perceive their environment, process information, and execute appropriate actions to achieve their objectives. Autonomous control systems are often associated with robotics, drones, self-driving cars, and various other autonomous vehicles. They typically involve complex algorithms for navigation, obstacle avoidance, decision-making, and sometimes machine learning to improve their performance over time. These systems are designed to operate safely and efficiently in dynamic and uncertain environments, often requiring a combination of advanced sensors such as cameras, lidar, radar, and GPS, as well as sophisticated software to interpret sensor data and make decisions in real time.

Autonomous systems play a pivotal role in modern robotics by enabling robots to operate independently and adapt to changing environments without constant human oversight. These systems empower robots to perform a wide range of tasks, from manufacturing and logistics to search and rescue missions, exploration, and even household chores. By integrating sensors, such as cameras, lidar, and proximity sensors, with powerful computing systems and sophisticated algorithms, autonomous robots can perceive their surroundings, make decisions, and execute actions with precision and efficiency.

Using robots in place of human labor has become increasingly common across various industries due to the numerous benefits they offer. Robots can perform repetitive, tedious, or physically demanding tasks with greater speed, accuracy, and consistency than humans. This substitution of labor with robots can lead to increased productivity, as robots can work around the clock without the need for breaks or rest, thereby optimizing production processes and reducing cycle times.

### SUMMARY OF INVENTION

Systems and methods for downward drilling robotic systems in accordance with embodiment of the invention are illustrated. One embodiment includes a drilling robot. The robot includes an outer casing, a chassis coupled to the outer casing, and a plurality of wheels. The drilling robot further includes at least one drive motor received at least partially in the chassis and configured to rotatably drive the plurality of wheels on a surface, an autonomous control system configured to control movement of the drilling robot along the surface, and a drilling module coupled to the housing that supports a drill for movement along a movement axis transverse to the surface.

In another embodiment, the movement axis is substantially perpendicular to the surface.

In a further embodiment, the drill comprises a drill housing, a drill motor disposed within the drill housing, a drill transmission configured to be driven by the motor, and a bit holder configured to be driven by the transmission and configured to removably support a drill bit.

In still another embodiment, the transmission is configured to transmit at least one of rotational motion or axial motion to the bit holder.

In a still further embodiment, the drilling module comprises a guide rail fixedly coupled to the outer casing, a first slider movably mounted to the guide rail and configured to support a linear movement of the drill along the movement axis.

In yet another embodiment, the drilling module includes a second slider movably mounted to the guide rail.

In a yet further embodiment, the drilling module includes a shock absorption module configured to dampen movement of the drill along the movement axis.

In another additional embodiment, the shock absorption module comprises a floating block coupled to a rear end of the drill, a guiding block supported relative to the outer casing, at least one spring that biases the floating block away from the guiding block along the movement axis.

In a further additional embodiment, the drilling robot further includes at least one pin that constrains a travel distance of the floating block away from guiding block.

In another embodiment again, the drilling robot further includes an electronic control unit configured to control movement of the drill along the movement axis.

In a further embodiment again, the electronic control unit is coupled to a position detection sensor.

In still yet another embodiment, the electronic control unit is configured to control actuation of the drill motor.

In a still yet further embodiment, the drilling robot further includes a sensor or a camera positioned proximate the drill bit to sense a depth of a hole drilled by the drill bit, wherein the electronic control unit is configured to analyze data received from the sensor or the camera to determine a depth of the hole.

In still another additional embodiment, the drilling robot further includes an actuator arm in engagement with the second slider configured to move the second slider along the driller along the movement axis, and an actuator motor.

In a still further additional embodiment, the drilling robot further includes a lead screw that is rotatable by the actuator motor to cause a linear movement of the actuator arm along the movement axis.

In still another embodiment again, the drilling robot further includes an encoder associated with the actuator motor, and a controller that controls a supply of power to the actuator motor in a closed-loop speed control based on feedback from the encoder to maintain a substantially steady movement of the driller during a drilling operation.

In a still further embodiment again, the drilling robot further includes a dust cover in contact with at least a portion of the drill proximate the rear end thereof or the second slider, and configured to contain passage of dust past the second slider, wherein the dust cover is moveable with the actuator arm.

In yet another additional embodiment, the drilling robot further includes a drilling guide jig proximate the drill bit and including an opening through which the drill bit extends when the drill bit is aligned along the movement axis.

In a yet further additional embodiment, the drilling guide jig comprises a die jig supporting a die core, wherein the die core comprises the opening.

In yet another embodiment again, the die jig comprises a first piece and a second piece pivotably mounted to the first piece between an open position and a closed position via a pivot member extending substantially parallel to the movement axis, and clasp that secures the second piece to the first piece in the closed position.

In another additional embodiment again, the drilling robot further includes an access door coupled to the outer casing to allow access to the drill, wherein the second piece swings into the open position in the direction of the access door.

In a further additional embodiment again, the drilling robot further includes a dust collector head mounted below the bit alignment structure and adjacent a location where a drill bit coupled to the drill engages the surface, the dust collector head including a substantially U-shaped body defining an inlet that at least partially surrounds the drill bit.

In still yet another additional embodiment, the drilling robot further includes a vacuum coupled to the outer casing in fluid communication with the dust collector head.

In yet another additional embodiment again, the vacuum includes a vacuum motor configured to provide suction to the dust collector head.

In a yet further additional embodiment again, the vacuum motor is configured to be automatically turned on when the drill motor is turned on and configured to be automatically turned off when the drill motor is turned off.

In still yet another additional embodiment again, the drilling robot further includes a sensor configured to sense an ID tag associated with a drill bit and output a signal, and a controller that controls an operation of the robot according to the ID tag.

In a still yet further additional embodiment, the controller is configured to prevent a drilling operation if the ID tag is not compatible with a target drilling location.

In yet another further additional embodiment, the drilling robot further includes a battery configured to power the robot motor.

In yet another further additional embodiment again, the drilling robot includes a battery receptacle including a terminal block and the battery is a removeable battery pack mounted in the battery receptacle.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A-1B illustrate a drilling robot in accordance with an embodiment of the invention.

FIGS. 2A-2B illustrate a drilling module in accordance with an embodiment of the invention

FIG. 3 illustrates a lead screw actuator in accordance with an embodiment of the invention.

FIGS. 4A-4B illustrate an upper slider in accordance with an embodiment of the invention.

FIGS. 5A-5B illustrate a process for rebar detection during drilling in accordance with an embodiment of the invention.

FIG. 6A illustrates an alternative view of the drilling robot with an access door opened for drill bit replacement in accordance with an embodiment of the invention.

FIG. 6B illustrates process for drill bit and die core installation and replacement in accordance with an embodiment of the invention.

FIGS. 7A-7B illustrate a drilling guide jig in accordance with an embodiment of the invention.

FIG. 8 illustrates a process flowchart of electronic control unit (ECU) control in accordance with an embodiment of the invention.

FIG. 9 illustrates a process for downward drilling in accordance with an embodiment of the invention.

FIG. 10 illustrates a drilling robot coordination process in accordance with an embodiment of the invention.

FIG. 11 illustrates a side view of a drilling robot in accordance with an embodiment of the invention.

FIG. 12 illustrates a bottom-up view of an installed vacuum module in accordance with an embodiment of the invention.

### DETAILED DESCRIPTION

There are many labor-intensive tasks that need to be performed in all types of construction jobs. One such labor-intensive task is drilling. In the construction industry, drilling is a vital process integral to infrastructure projects such as building foundations, tunnels, bridges, roads, and large-scale developments. Among these applications, construction drilling plays a particularly important role in the development and operational success of data centers. As highly specialized facilities that house essential IT infrastructure such as servers, storage systems, and networking equipment, data centers require precise environmental control, high load-bearing capacity, and reliable utility access. Construction drilling supports these needs, making it an indispensable part of data center development.

Achieving precise accuracy in construction drilling may also be challenging for human labor due to the physical demands of handling heavy equipment and dealing with site conditions like dust, noise, and uneven grounds. Maintaining focus and control over long shifts is difficult, especially with constant vibrations from the tools, which can cause fatigue and reduce precision. This can make it easy for human labor to misalign drill angles, over-drill, or under-drill, which are mistakes that can compromise the integrity of a project. Requirements associated with accuracy may be heightened in projects where downward drilling is required, as downward drilling in environments such as the first floor and basements can have demanding anchoring and seismic requirements. Accurate drilling depth, angle, and alignment are essential to meet various building codes and regulations, as misalignment, over-drilling, or shallow holes can weaken anchor performance and lead to anchor failure, which could compromise the stability and integrity of a structure during seismic events.

With so many factors affecting accuracy, many construction sites are attracted to the idea of drilling robots to reduce human error and improve precision. Drilling robots are machines that use sensors and computer-controlled systems to perform precise drilling tasks and can bore into materials like metal, concrete, and rock with a high level of accuracy and consistency. Drilling robots can maintain their accuracy and efficiency in long periods of operation to significantly increase productivity.

Current drilling robots, however, face several key limitations that impact their efficiency, adaptability, and cost-effectiveness. They may struggle to operate in unfamiliar environments where navigation and stability are critical. Precision may be affected by vibrations from drilling, which, in turn, can affect the accuracy of drilling. In projects where downward drilling is involved, gravity may also cause debris and drilling fluids to accumulate at the bottom of the hole, leading to blockages, increased friction, and faster bit wear. These obstacles call for specialized systems to manage the drills for smoother operations.

Systems and methods in accordance with many embodiments provide a lightweight robotic platform capable of performing downward drilling while ensuring the stability of the overall platform. In various embodiments, the robotic platform is capable of autonomous operation. In many embodiments, robotic platforms utilize stabilization mechanisms to reduce the misalignment of drill bits. Several embodiments reduce oscillations during drilling such that the drill bits are able to remain perpendicular to the drilling surface during drilling. Various embodiments compartmentalize the platform such that the shock from drilling is properly absorbed and that the controllers and processors are protected during drilling. In certain embodiments, robotic platforms include RFID readers to correctly identify drill bits for certain tasks and projects where the drill bits are labeled with RFID tags. Robotic platforms in accordance with numerous embodiments include cameras for inspecting the drill bits and determining whether the drill bits are worn out. Inspection of the drill bits may be performed using machine learning algorithms and image recognition. Some embodiments train a convolutional neural network to determine whether the drill bits are worn out and learn the wear rate of drill bits. Many embodiments are able to utilize cameras to determine if the drilled holes are the correct ones. In numerous embodiments, robotic platforms include a vacuum to clean up debris as drilling takes place. This can be especially helpful during downward drilling such that the drill holes are as clean as possible and there is minimal debris that could affect the drill angle of the drill.

### Drilling Robots

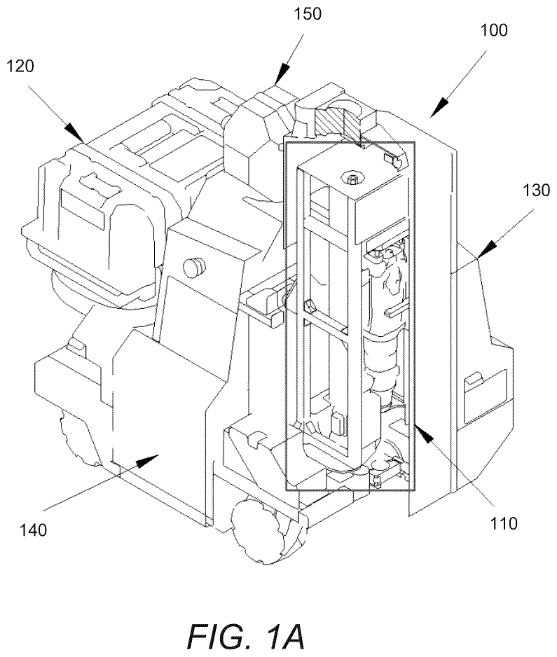

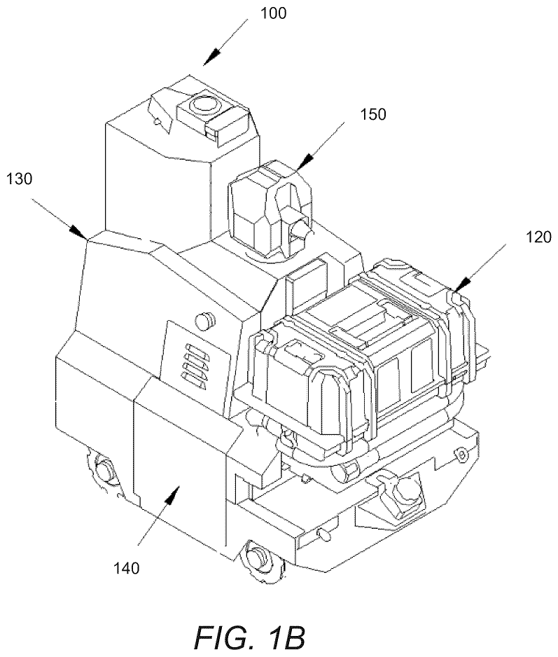

Drilling robots in accordance with many embodiments perform downward drilling with stability while maintaining a lightweight platform. A drilling robot in accordance with an embodiment of the invention is illustrated in FIGS. 1A-1B. As illustrated in FIG. 1A, drilling robot 100 includes a drilling module 110, a vacuuming module 120, an outer casing 130, a robot chassis 140, a navigation beacon 150, and a battery (not shown) received in the outer casing 130 and configured to power the robot 100. Details of each component on the drilling robot are described further below. FIG. 1B illustrates the drilling robot in accordance with an embodiment of the invention from an alternative angle.

Although a specific example of a drilling robot is illustrated in this figure, any of a variety of drilling robots can be utilized to perform processes for downward drilling similar to those described herein as appropriate to the requirements of specific applications in accordance with embodiments of the invention. Each component on the drilling robot may be of a variety of architectures. Drilling modules in accordance with certain embodiments include specialized circuitry to transmit and receive information regarding scheduled tasks wirelessly. Indeed, any number of different implementations can be utilized without departing from the scope or spirit of the invention.

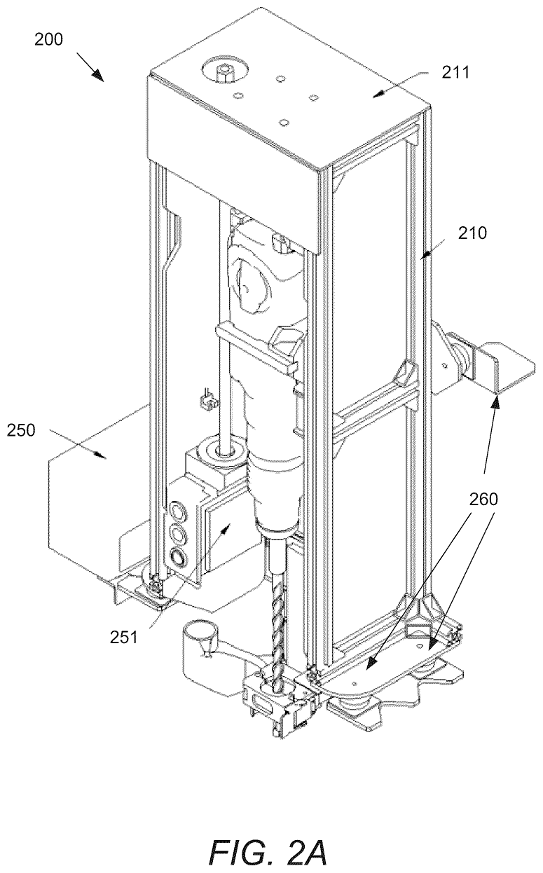

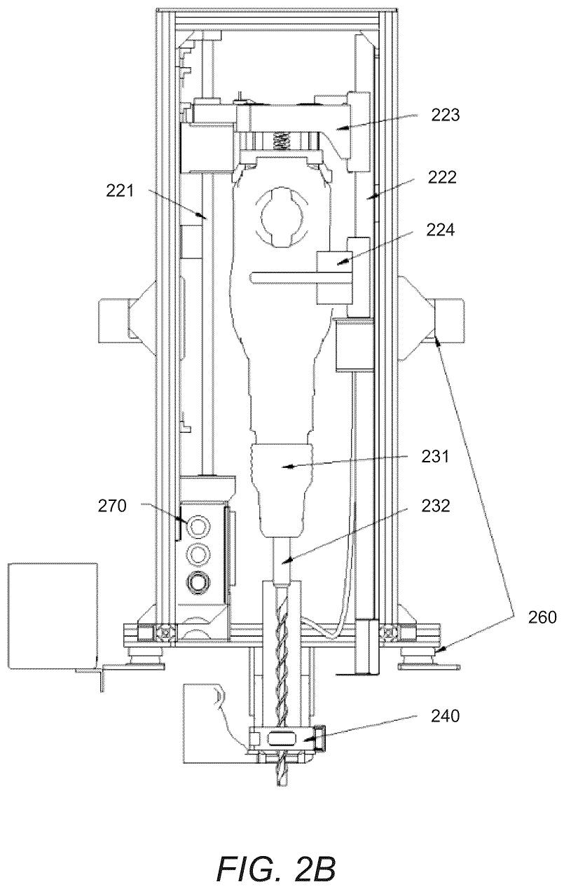

A drilling module in accordance with an embodiment is illustrated in FIGS. 2A-B. Drilling module 200 includes an alloy frame 210 and a carbon plate 211. The drilling module 200 further includes a lead screw actuator 221, a lead screw motor 2214, a linear guide rail 222, an upper slider 223, a lower slider 224, a driller 231, a drill bit 232, a drilling guide jig 240, an electronic control unit (ECU) 250, an RFID drill bit identifier 251, a shock absorption frame module 260, and a human-machine interface (HMI) 270. In an embodiment, the driller 231 may be a DEWALT® DCH614 rotary hammer drill (or a portion thereof) sold by DeWalt Industrial Tool Co. of Towson, Maryland, and may include a drill housing, a drill motor received in the drill housing, an output tool holder (e.g., an SDS bit holder) configured to removably receive the drill bit 232, and a drill transmission received in the housing and configured to transmit rotary motion of the motor to rotary and/or axial movement of the tool holder. The hammer drill may have a mode select switch that enables a user to switch among three modes of operation-drilling, hammer drilling, and hammering. ECUs in accordance with various embodiments are configured to read values from an encoder coupled to the lead screw motor 2214 and control the lead screw motor's direction, speed, and travel distance. In many embodiments, lead screw motors drive the rotation of lead screw actuators, which can cause upper sliders to slide up or down. Upper sliders may be affixed to the driller such that when the upper slider moves, the driller moves with the upper slider. Upper sliders and lower sliders may be connected to the linear guide rail such that the driller stays in the designated path of movement without deviation. Drillers can move vertically through controls provided by the ECU.

In many embodiments, alloy frames and carbon plates are connected using anti-vibration screws to form a main frame of the drilling module. Structurally, main frames may be connected to robot chassis via shock absorption frame modules. In the example illustrated in FIGS. 2A and 2B, four shock absorption frame modules are mounted on the carbon plate at the bottom of the drilling module, serving three primary functions: (1) supporting the entire weight of the drilling module, (2) providing the downward force required for drilling operations, and (3) absorbing vertical vibrations generated during drilling. Additional shock absorption frame modules may be installed on the carbon plate at the rear side of the drilling module from the perspective of FIG. 2B to secure the drilling module such that it remains perpendicular to the horizontal plane of the chassis, and mitigate horizontal vibrations produced during drilling.

Although a specific example of a drilling module is illustrated in this figure, any of a variety of drilling modules can be utilized to perform processes for downward drilling similar to those described herein as appropriate to the requirements of specific applications in accordance with embodiments of the invention.

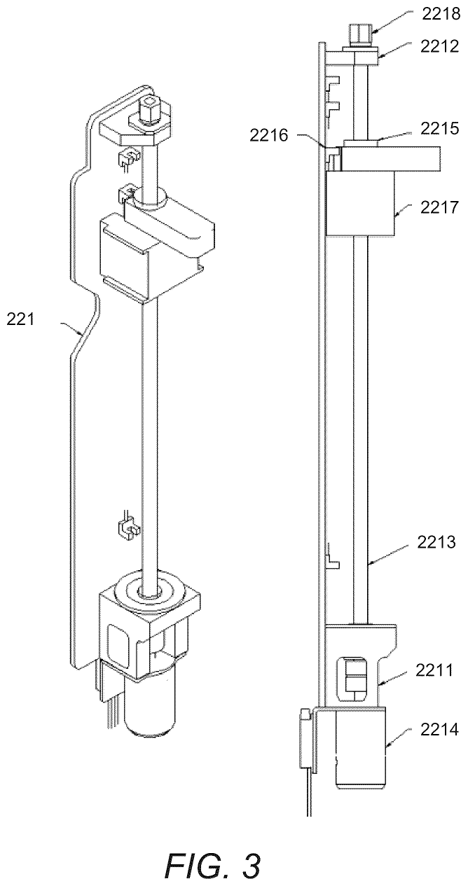

Lead screw actuators in accordance with various embodiments are responsible for driving movement of the driller housing along an axis that is generally perpendicular to the work surface. A lead screw actuator in accordance with an embodiment is illustrated in FIG. 3. Lead screw actuator 221 includes a coupling module 2211, an upper bearing 2212, a trapezoidal lead screw 2213, the lead screw motor 2214 with an encoder, a screw nut 2215, a calibration sensor 2216, a dust cover 2217, and a manual operation interface 2218. Calibration sensors in accordance with several embodiments align the lead screw motor encoder values retrieved by the ECU with the actual physical position of the upper slider. In various embodiments, if manual operation is needed, drillers can be moved up and down by rotating the manual operation interface with a wrench. Trapezoidal lead screws in accordance with many embodiments convert rotational energy provided by the motor into linear vertical movements of the driller housing.

Linear guide rails in accordance with many embodiments are connected to the carbon plates of the drilling module using anti-vibration screws. Lead screw actuators, coupling modules and upper bearings may be attached to the carbon plates of the drilling module via anti-vibration screws. As shown in the example of FIG. 3, the trapezoidal lead screw 2213 is installed between the motor base 2211 and the upper bearing 2212. The top end of the trapezoidal lead screw 2213 is connected to manual operation interface 2218, while the bottom end is connected to the lead screw motor 2214 through the coupling module 2211. During normal operation, the lead screw motor can drive the coupling module to rotate, which in turn rotates trapezoidal lead screw. In the event of a power failure, the trapezoidal lead screw can be manually rotated by turning the manual operation interface with a wrench.

Referring to the example illustrated in FIG. 3 again, the screw nut 2215 is mounted on the trapezoidal lead screw 2213 via threads and is fixed to the upper slider 223. Upper sliders in accordance with several embodiments are installed on linear guide rails. During operation, the lead screw motor generates torque that can be applied to the trapezoidal lead screw. The trapezoidal lead screw may rotate and cause the threads to push against the screw nut. The screw nuts and upper sliders may be driven by the pushing force to move vertically along the axis of the trapezoidal lead screw, thereby converting rotational motion into linear displacement. Linear guide rails can assist in guiding the upper sliders, allowing the upper sliders to move with low friction only in the vertical direction.

One or more dust covers in accordance with many embodiments may at least partially envelop the lead screw and/or the guide rails to prevent dust from entering. In some embodiments, dust covers may include flexible bellows. The encoder coupled to the lead screw motor can read the number of rotations and angular values of the lead screw motor in real-time to calculate the vertical position of the driller. In situations where there is no power, the lead screw motor encoder may not be able to obtain encoder values. Therefore, lead screw motor encoders in accordance with various embodiments may calibrate, e.g., at least once upon every restart. In many embodiments, drillers are moved upward until the position detection sensors are triggered, at which point the ECUs can reset the encoder value to the zero position.

Although a specific example of a lead screw actuator is illustrated in this figure, any of a variety of lead screw actuators can be utilized to perform processes for driving drillers similar to those described herein as appropriate to the requirements of specific applications in accordance with embodiments of the invention. Various types of motors with encoders may be utilized in lead screw actuators to drive the drills without departing from the scope or spirit of the invention.

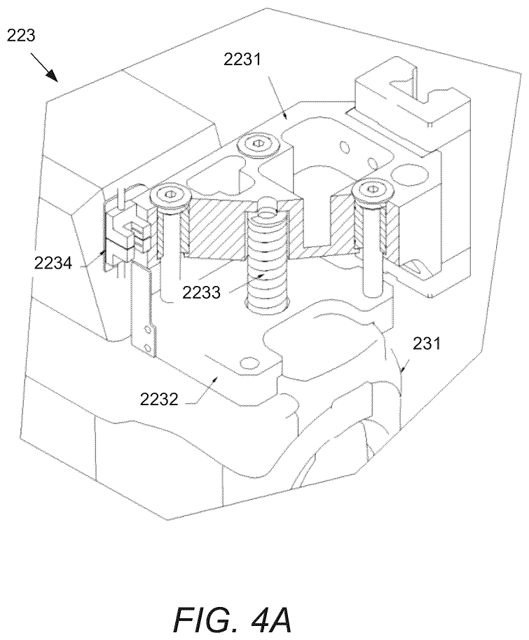

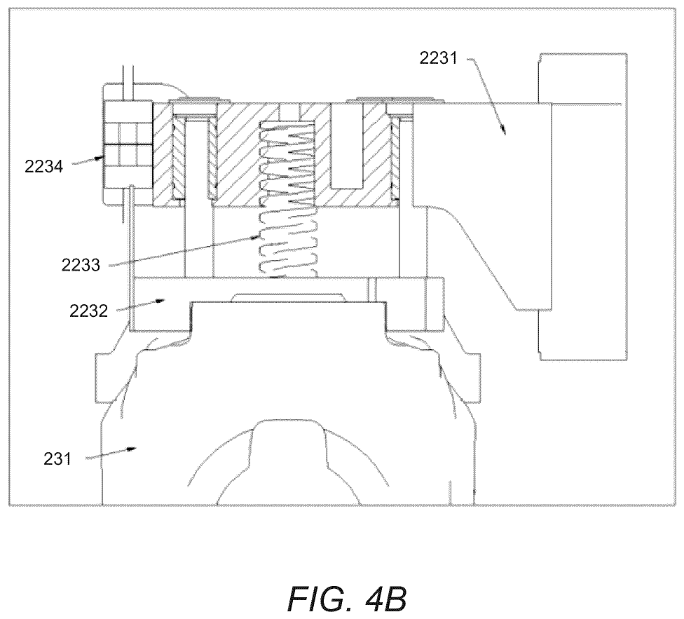

Due to the nature of drilling projects, intense vibrations can occur and affect the platform if they are not properly absorbed. In many embodiments, shock absorption is accomplished through two separate absorption mechanisms installed on the driller robot. Various embodiments utilize a shock absorption spring included in the upper slider as the first shock absorption mechanism to absorb vibrations in the vertical direction. The second level of the shock absorption mechanism may be omnidirectional and can be achieved by the shock-absorbing blocks in the shock absorption frame module installed on the frame. An upper slider in accordance with an embodiment is illustrated in FIGS. 4A-B. Upper slider 223 includes a guiding block 2231, a floating block 2232, a shock absorption spring 2233, and a position detection sensor 2234. In various embodiments, guiding blocks are connected to the lead screw actuator and the linear guide rail within the drilling module. Floating blocks may be connected to the driller. Floating blocks in accordance with selected embodiments move freely within a certain range in the vertical direction, where their positions can be detected by the position detection sensor. By determining the degree of movement that floating blocks are undergoing, which may include a spring-released position, a fully compressed position, or an intermediate position, ECUs can determine the force that is currently being exerted on the drill bit, which can assist in determining whether the drilling has been completed or if the drill has encountered objects such as metal rebar. Floating blocks and guiding blocks may be connected through the shock absorption spring such that vibrations can be dampened and absorbed.

As shown in FIGS. 4A and 4B, the floating block 2232 is aligned with the mounting holes of the driller, allowing it to be securely fixed on the driller. In some embodiments, drillers may be provided separately as a standalone power tool and the mounting holes may be mounting holes formed in the standalone power tool. Floating blocks may be connected to guiding blocks via a high-stiffness spring and multiple alloy pillars. Alloy pillars in accordance with several embodiments can assist in keeping the driller perpendicular during the drilling process, while the high-stiffness spring can provide shock absorption and the necessary pressure required for drilling.

Position detection sensors in accordance with several embodiments include but are not limited to optical sensors to detect the positioning of the upper sliders. ECUs can monitor the lead screw motor drive current, e.g., at a frequency of 1,000 Hz. Generally, there is a mathematical relationship between the force applied to the drill bit and the amount of current drawn by the lead screw motor. The magnitude of the force applied to the drill bit can be calculated based on the curve of current changes.

Although a specific example of a shock absorption module is illustrated in this figure, any of a variety of shock absorption modules can be utilized to perform processes for absorbing vibrations due to drilling similar to those described herein as appropriate to the requirements of specific applications in accordance with embodiments of the invention. Various types of floating and guiding blocks may be utilized to assist with shock absorption without deviating from the architecture of the shock absorption modules.

ECUs in accordance with various embodiments capture the lead screw motor encoder values both at the moment the drill bit makes contact with the work surface and upon the completion of the drilling operation. In many embodiments, ECUs calculate the difference between these two values and the number of rotations of the lead screw and apply a conversion to determine the depth of the hole (e.g., in millimeters or inches). Depths of each hole may be reported to the system ECU. For example, when the drill bit first touches the work surface, the motor encoder value, denoted as d1, may be read and obtained from the ECU. After the drilling is completed and the drill bit stops rotating and touches the bottom of the hole, the motor encoder value at this point, denoted as d2, may be read and obtained from the ECU again. Changes in lead screw motor encoder values may be calculated by the difference of d2−d1, along with counting a total number of rotations, which can then be converted through an algorithm to determine the depth the drill bit has moved vertically downward from the point where it first touched the work surface. This vertical downward movement distance can be considered as the depth of the hole.

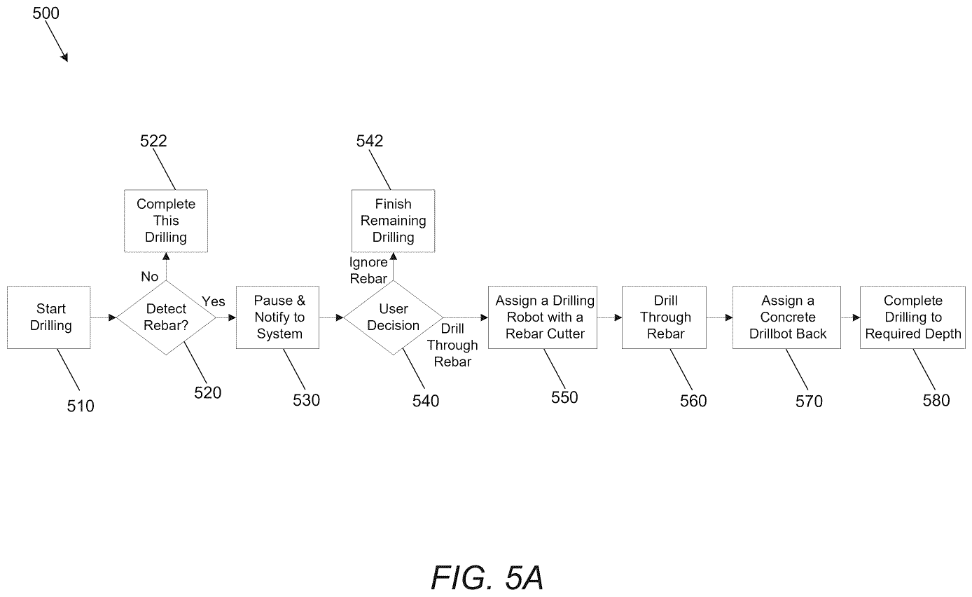

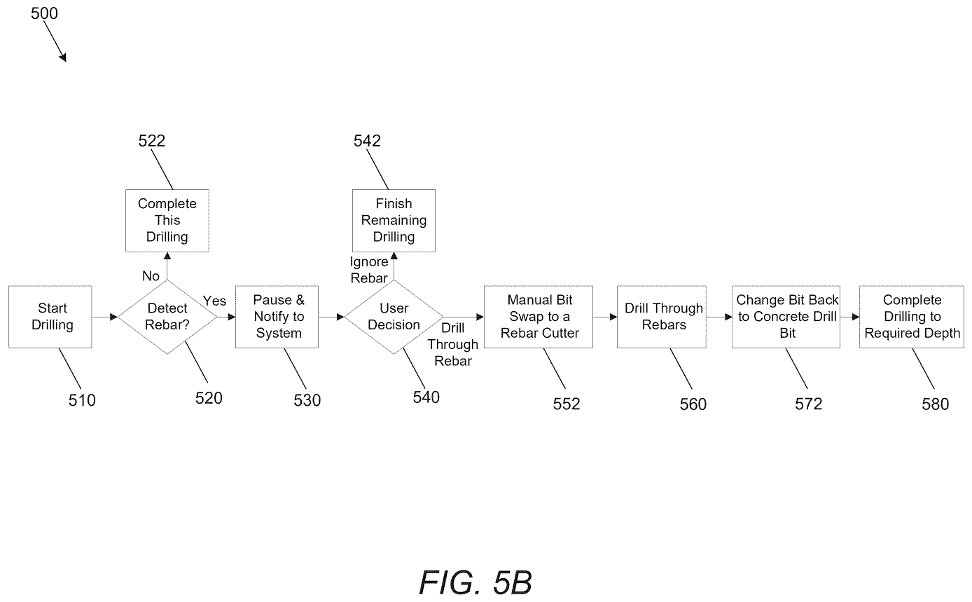

In several embodiments, ECUs check for the presence of rebar in concrete during the drilling process. A process for rebar detection during drilling in accordance with an embodiment is illustrated in FIGS. 5A-B. Process 500 starts (510) drilling, and determines whether a rebar is detected (520) during drilling. If no rebar is detected, process 500 proceeds to complete (522) the drilling task normally. However, if rebars are detected, process 500 pause (530) work on the current location, move to the next drilling location, and notify the system. A user monitoring the progress of drilling may be prompted to decide (540) whether to drill through the rebar at the detected location. Process 500 directs the drilling robot to finish (542) remaining drilling tasks if the user decides to ignore the hole with the detected rebar. If the user decides to drill through the rebar, process 500 assigns (550) the task to another drilling robot equipped with a rebar cutter to drill (560) through the rebar. In various embodiments, drilling robots with rebar cutters may detect hole depths after cutting through the rebar to determine whether additional drilling is required by a drilling robot equipped with a drill, at which point the user may decide again whether to continue drilling past the cut. Once a rebar is drilled through, process 500 assigns (570) a drilling robot with a concrete drill bit to complete (580) drilling to the required drilling depth.

In an alternate version of process for rebar detection during drilling illustrated by FIG. 5B, instead of assigning a drilling robot already equipped with a rebar cutter, process 500 manually swaps (552) the drill bit for a rebar cutter. Process 500 changes (572) the drill bit from the rebar cutter back to the concrete drill bit after the detected rebars are drilled through. Systems and methods in accordance with various embodiments provide efficient handling of both rebar and concrete drilling tasks.

While specific processes for rebar detection during drilling are described above, any of a variety of processes can be utilized to perform rebar detection during drilling as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

The installation of drill bits, or other bit attachment such as (but not limited to) rebar cutters can be a standardized replacement procedure. Since drill bits are an expendable part, manual inspections of the drill bits'condition can be performed in accordance with several embodiments during replacement. Some embodiments include using the HMI to manage the vertical movement of driller, such that the replacement of drill bits can be done more efficiently. In many embodiments, drill bit replacement includes the implementation of a dual verification system involving both human oversight and mechanical checks to offer an additional layer of security by further checking that the drill bits are correctly installed. In addition, RFID drill bit identifiers can automatically identify the drill bit's parameter information and upload it to a robot fleet management system (FMS) for verification, hence reducing the need for manual measurements or consulting manuals, which further improves efficiency and accuracy. Drilling robots can be fitted with specialized bits for specific tasks. In many embodiments, the drill bit parameter information comprises information about the type of bit. For example, rebar cutting drill bits can be used for cutting rebar, and the attached RFID tag can be used to differentiate the rebar cutting drill bit from a conventional drill bit. Generally, as each type of drill bit is equipped with a tag, RFID drill bit identifiers in accordance with several embodiments automatically identify and/or track the type of the drill bit being installed to notify the system during each installation as an additional layer of verification.

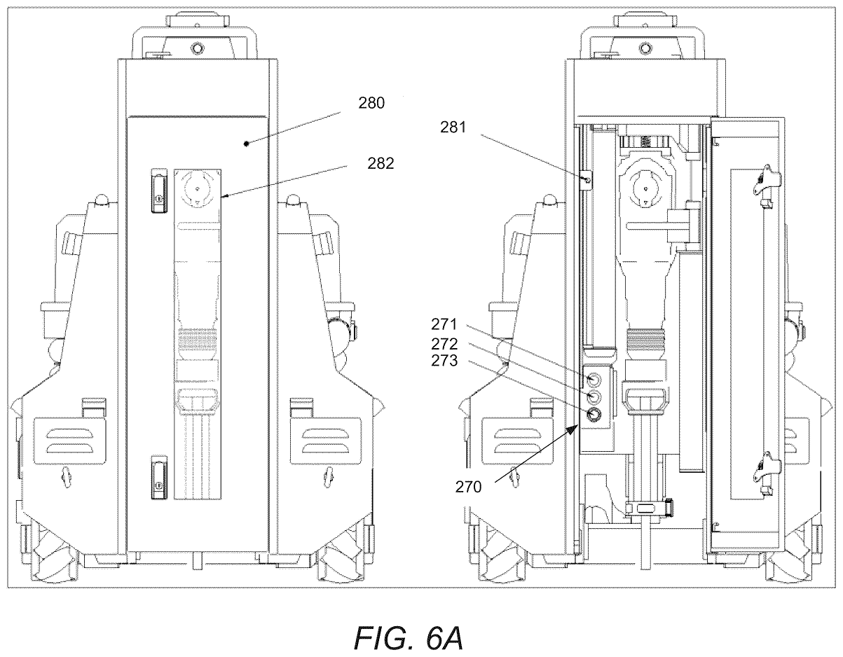

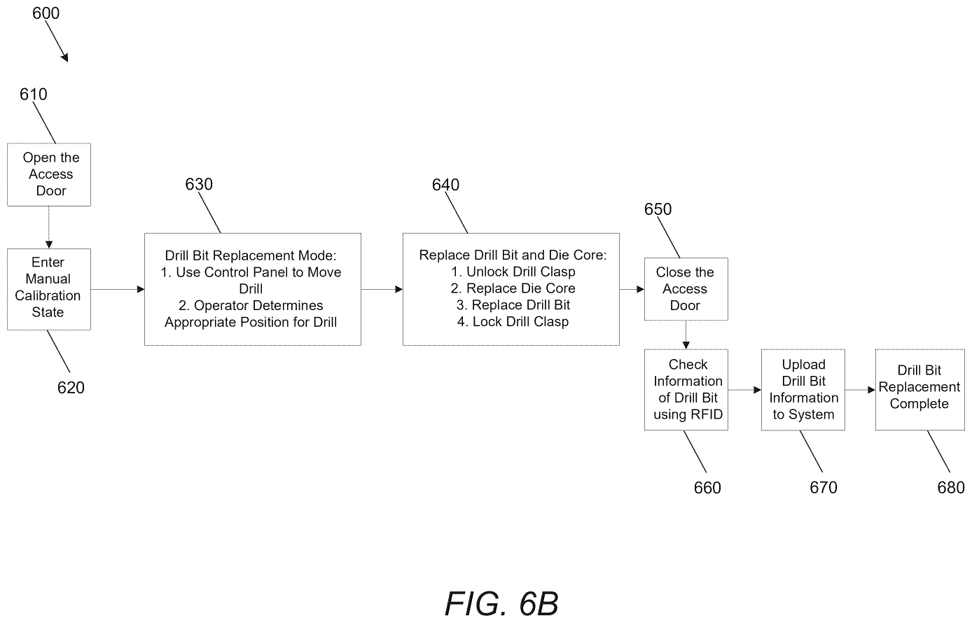

An alternative view of the drilling robot with an access door opened for drill bit replacement in accordance with an embodiment of the invention is illustrated in FIG. 6A. To replace the drill bit, workers can first open the access door 280 (which may be at least transparent in part) of the drilling module, which causes the controller to disconnect all power sources to components including the drill, dust collector and the overall chassis, and retain only the power to the motor in the lead screw actuator. The access door may include a magnetic sensor 281 that detects when the access door is open, and users can monitor the real-time drilling through observation window 282.

A process for drill bit and die core installation and replacement in accordance with an embodiment is illustrated in FIG. 6B. HMIs in accordance with several embodiments are active in this state. HMI 270 includes at least a red LED 271, a green LED 272, and a control panel 273. Control panels in accordance with several embodiments include at least one button to move the drilling module vertically. In some embodiments, any operations received at the software level are not executed in this state. The system can then enter a manual calibration state.

In some embodiments, the robot may be unaware of the type of drill bits or die cores that may be installed, and a manual calibration process may be performed on the drilling module such that the drilling module is positioned appropriately for the type of drill bits or die cores that may be installed. During manual calibration, process 600 opens (610) the access door to enter (620) the manual calibration state. In the manual calibration state, process 600 enters (630) the drill bit replacement mode by using the control panel to manually direct the drill to move vertically upwards and reset back to the upmost position, where the position detection sensor can detect the drill, at which point both the red and green LEDs will illuminate simultaneously, and the robot can then transition to a replacement mode. In various embodiments, processes use the at least one button on the control panel to move the drill into a proper position as determined by the workers to facilitate easy replacement of drill bits. Drills in accordance with a number of embodiments remain stationary upon releasing of the at least one button on the control panel for the safe replacement of drill bits and die cores. Process 600 replaces (640) drill bits and die cores in the replacement mode, where workers may unlock the drill clasp, replace the die core, replace the drill bit, and then lock the drill clasp. After each drill bit replacement, drilling robots may recalibrate by detecting the relationship between the encoder values and the actual vertical position of the driller.

Process 600 closes (650) the access door, and the drill bit may be retracted to the highest position in the drill and activated to test whether the installation was done properly. When the access door is closed, it indicates that the drill bit and die core have been installed or replaced. Magnetic sensors can detect the closing signal of the door and automatically initiate this step. Process 600 checks (660) for information on the installed drill bit using a RFID drill bit identifier and uploads (670) the drill bit information to the system. If the RFID drill bit identifier verifies that the correct drill bit was installed, process 600 completes (680) the drill bit replacement by automatically moving the drill bit to the corresponding starting position according to the type of drill bit that was installed, and the system can enter an idle state. If the RFID drill bit identifier fails to verify the drill bit or confirms that an incorrect drill bit was installed, the system may enter an error state. In many embodiments, status changes like the ones mentioned above are uploaded and reflected in the FMS for better task assignment and coordination. ECUs in accordance with many embodiments set the starting position of the driller based on the type of drill bit installed. Drilling modules in accordance with a variety of embodiments can determine the starting positions for different types of drill bits using a database associated with the ECU.

While specific processes for drill bit and die core replacement are described above, any of a variety of processes can be utilized to perform drill bit and die core replacement as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

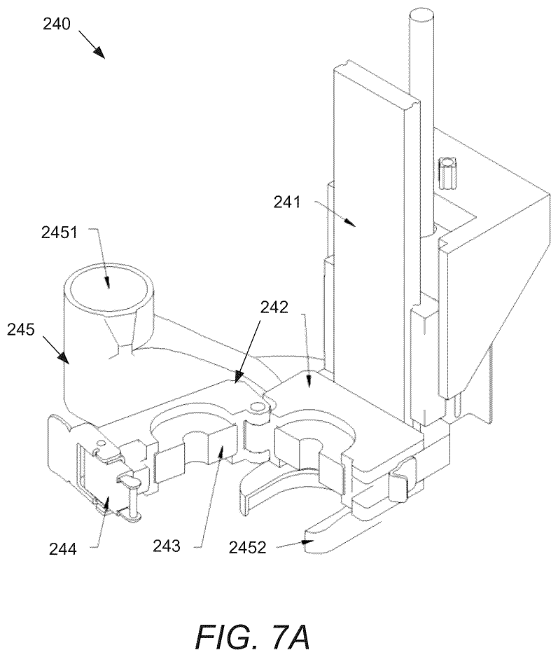

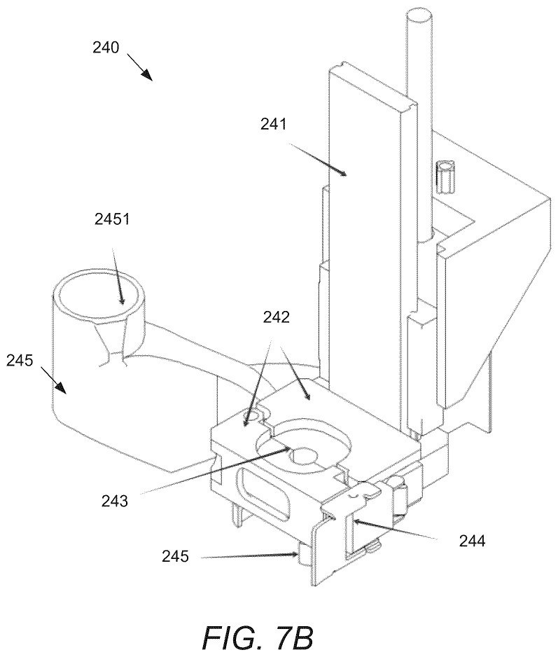

Several embodiments utilize a drilling guide jig to help keep drill bits on the desired path of movement. During the drilling process, vibrations can cause deviations in the movement of the drill bits, which, in turn, may affect the accuracy of the positions of the drilled holes. A drilling guide jig in accordance with an embodiment is illustrated in FIGS. 7A-7B. Drilling guide jig 240 includes a slide rail 241, a die jig 242, a die core 243, a drill clasp 244, a dust collector head 245, a vacuum hose port 2451, and a dust inlet 2452. Drilling guide jigs in accordance with several embodiments secure the drill to a designated drilling path. In a variety of embodiments, dust collector heads are attached to drilling guide jigs, which allow vacuum modules to start operating simultaneously with the drilling process such that the areas surrounding the drilled holes are cleaned up in time such that there is no debris affecting the path of the drill bits. Vacuum hose ports in accordance with several embodiments are connected to dust extraction pipes. As illustrated in the example of FIG. 7A, when the vacuum is operational, dust and debris can enter through the dust inlet 2452 and then move through the vacuum hose port 2451 into the vacuum's piping system, where they are ultimately collected within the vacuum.

In various embodiments, the main function of the drilling guide jig is to ensure that the drill remains aligned (e.g., perpendicular) to the drilling surface during movement. Drilling robots in accordance with many embodiments are equipped with an IMU sensor, which can detect the angle between the vehicle body and the ground in real time. IMU sensors in accordance with many embodiments may include one or more of accelerometers, inclinometers, and/or gyroscopes that can measure the angle between the robot's horizontal plane and the horizon. Drilling guide jigs can firmly hold the drill bit even while it is rotating and restrict the drill bit from deviating in any other direction, ensuring it remains perpendicular to the ground. Under such circumstances, systems and methods in accordance with numerous embodiments can drill such that the drilled hole is perpendicular to the ground plane.

Although a specific example of a drilling guide jig is illustrated in this figure, any of a variety of drilling guide jigs can be utilized to perform processes for stabilization during downward drilling similar to those described herein as appropriate to the requirements of specific applications in accordance with embodiments of the invention.

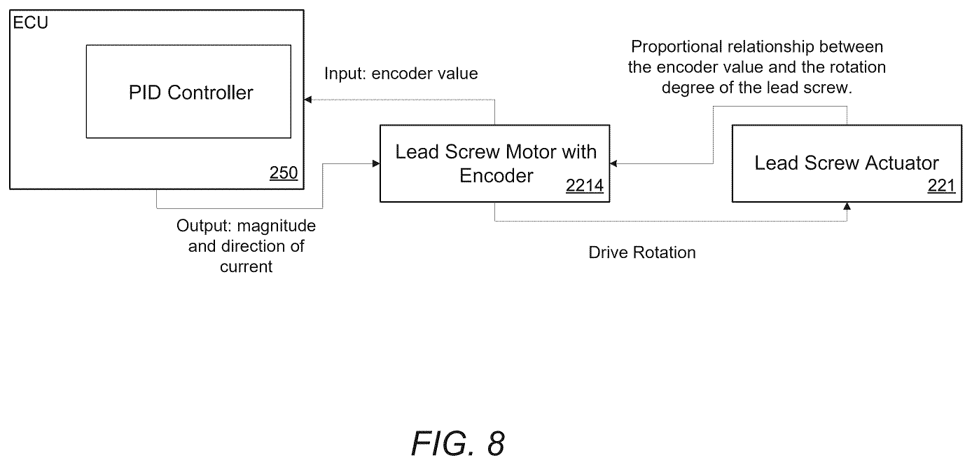

A process flowchart of ECU control in accordance with an embodiment is illustrated in FIG. 8. In several embodiments, ECUs read the values from the lead screw motor encoder and output a magnitude and direction of motion to control the speed and direction of the lead screw motor by regulating the magnitude and direction of the motor current. ECUs in accordance with various embodiments provide precise movement of the driller in the vertical direction by any specified distance. Once the user sets a target depth, drilling robots can initiate drilling upon contact with the ground and accurately move the drill vertically by the exact distance corresponding to the set depth. The lead screw motor can rotate and drive lead the screw actuator at a rate where the encoder value and the rotation degree of the lead screw have a proportional relationship. Therefore, ECUs can precisely control the rotational position of the motor through a PID (Proportional-integral-derivative) control. PID control is a widely used control algorithm in industrial applications, especially for linear actuator position control, and to make the actual position of the actuator precisely follow the desired position setpoint.

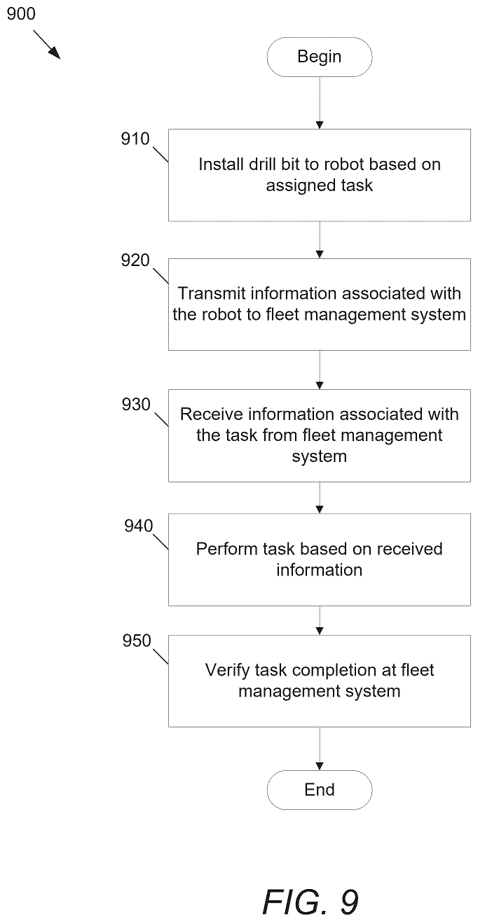

A process for downward drilling in accordance with an embodiment of the invention is illustrated in FIG. 9. Process 900 installs (910) a drill bit to the robot based on an assigned task. In several embodiments, appropriate drill bits are replaced and installed according to the required depth and diameter of the hole to be drilled. In many embodiments, drill bits are switched based on new tasks. Drilling robots transmit (920) information associated with the robot to an FMS. Information associated with the robot may include an identifier of a particular robot with a drill bit installed, as well as an acknowledgment that the drill bit has been properly installed. Transmission of this information provides for the registration of the robot at the FMS such that the system is aware of which robot is at a particular location.

Drilling robots receive (930) information associated with a task from the FMS. Information associated with a task can include, but is not limited to, the type of holes to be drilled, the dimensions of the holes to be drilled, as well as a submap that indicates the locations of the holes to be drilled. Drilling robots perform (940) the assigned task based on the received information and can verify (950) completion of the task with the FMS. In several embodiments, processes direct drilling robots to proceed to subsequent locations for drilling if there are additional tasks scheduled.

While specific processes for downward drilling are described above, any of a variety of processes can be utilized to perform downward drilling as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

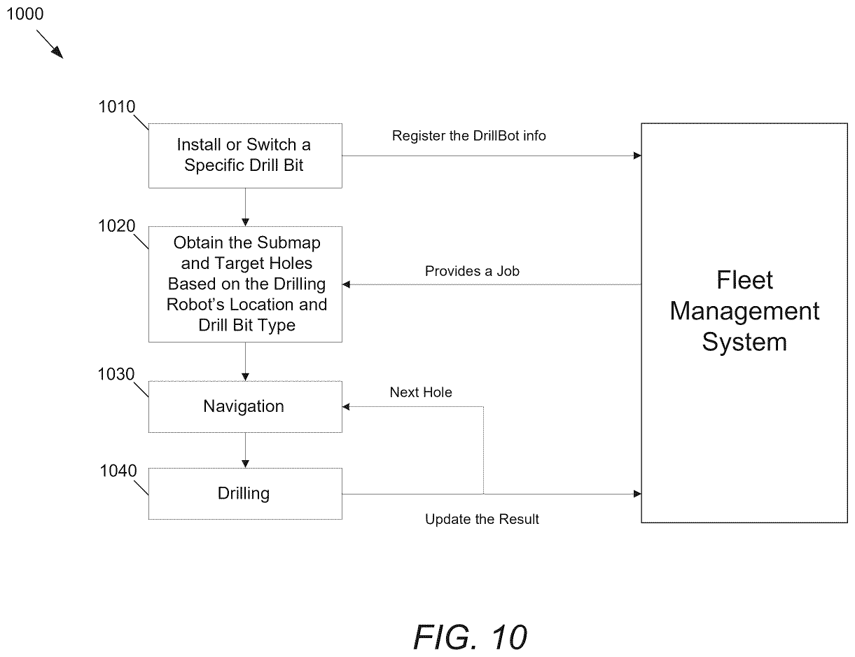

A drilling robot coordination process in accordance with an embodiment is illustrated in FIG. 10. Process 1000 installs or switches (1010) to a specific drill bit and communicates the drill bit information to the FMS. Process 1000 obtains (1020) submaps and target holes that the FMS provides based on the drilling robot's location and drill bit type. Process 1000 navigates (1030) drilling robots to various target holes based on the provided job. Process 1000 drills (1040) the target holes and provides updated drilling results to the FMS. By way of example, for a given job there may be three drilling robots, and three types of holes to be drilled with roughly the same quantity for each type. In this case, there is no need to change the drill bits, and each of the three drilling robots can complete the drilling of the three types of holes respectively. However, where for example there are five types of holes to be drilled, after one type of hole has been completely drilled, robots may undergo the drill replacement procedure as discussed above.

While specific processes for coordinating drilling robots are described above, any of a variety of processes can be utilized to coordinate drilling robots as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

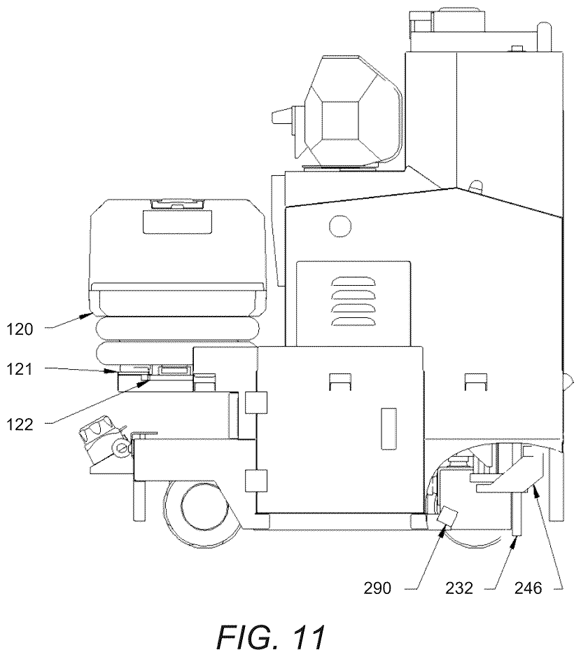

A side view of a drilling robot in accordance with an embodiment is illustrated in FIG. 11. Drilling robots may further include an inspection camera 290. In many embodiments, inspections cameras monitor the condition of the installed drill bit, the quality of drilled holes, and whether the dust from drilling has been removed by the vacuum. As illustrated in FIG. 11, the inspection camera is installed at position 290, with a view that can see both the drill bit and the hole.

Systems and methods in accordance with many embodiments detect drill bit wear utilizing image recognition algorithms. In various embodiments, inspection cameras capture images of drill bits that are currently installed. Image recognition algorithms in accordance with several embodiments preprocess the captured images to enhance clarity. In numerous embodiments, image recognition algorithms such as (but not limited to) convolutional neural networks, apply edge detection to the preprocessed images to identify contour changes to the drill bits and measure specific features of the drill bits such as cutting edge diameters of the drill bits. Measured features may be compared to reference data to determine deviations from expected dimensions. In many embodiments, drilling robots leverage the combination of inspection cameras and image recognition algorithms to determine the level of wear of the drill bits, and generate reports indicating whether the drill bits need to be replaced to enhance operational efficiency and equipment reliability.

Systems and methods in accordance with various embodiments provide predictive models that estimate the wear rate of drill bits using the historical data of drill bits and drilling tasks. In several embodiments, images captured by inspection cameras are further analyzed in conjunction with operational parameters such as drilling duration and material hardness. Through continuous learning, systems and methods in accordance with many embodiments anticipate wear patterns and predict the optimal time for drill bit replacement before significant performance degradation occurs. Prediction models can enhance operational efficiency and reduce downtime and maintenance costs to provide consistent high-quality outcomes.

After each drilling operation, inspection cameras in accordance with various embodiments capture images of the newly drilled holes. Captured images can be analyzed by image recognition algorithms to check for significant cracks or substantial surface irregularities such that the holes are structurally safe for use. Systems and methods in accordance with several embodiments evaluate whether dust has been adequately removed to confirm that there are no significant debris still remaining at the drilled holes. Upon completion of drilling and vacuuming, systems and methods in accordance with various embodiments upload the images of the drilling site to the user interface to inform the user of the status of the drilled holes. Drilling robots can automatically inspect the quality of the drilled holes and reduce the need for manual checks to increase overall operational efficiency.

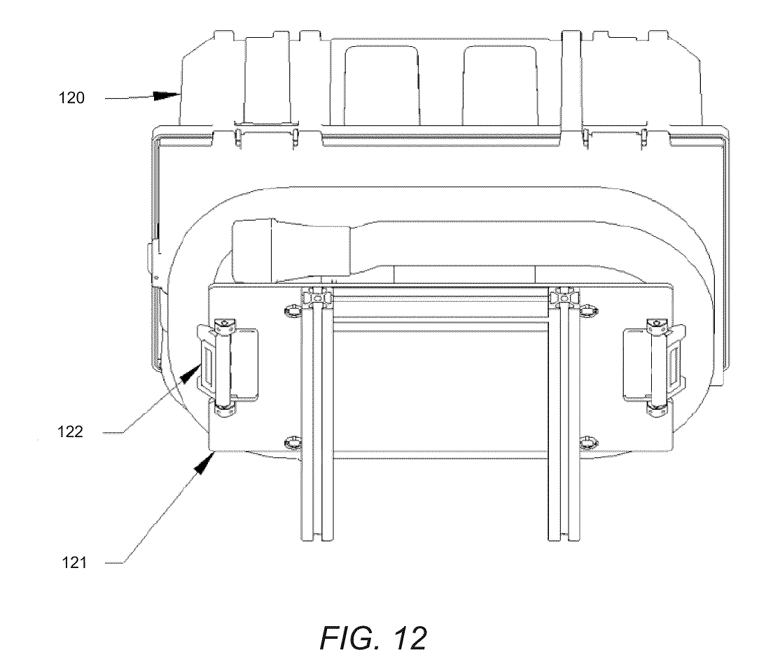

Drilling robots may produce a considerable amount of dust and debris during operation. Systems and methods in accordance with many embodiments include a vacuum module to remove the dust and debris produced during drilling such that drilling accuracy can be maintained while also keeping a clean environment. As shown in FIGS. 1 and 12, a vacuum module 120 in accordance with many embodiments is assembled in an easy-to-use box-shaped structure. In an embodiment, the vacuum module 120 includes a vacuum housing, a vacuum motor, a vacuum fan or impeller driven by the vacuum motor, circuitry to drive the vacuum motor, an inlet configured to receive ingress of dust and debris, a hose that connects the inlet to the vacuum hose port 2451 on the drilling jig, and a dust collection container or chamber. In an embodiment, the vacuum may be a DEWALT® FLEXVOLT® DCV585B Dust Extractor, sold by DeWalt Industrial Tool Co. of Towson, Maryland. The vacuum module is configured to collect dust and debris that is generated by the drill bit where it is drilling into a work surface. In some embodiments, an ECU in the robot may control and coordinate power delivery to the driller motor and the vacuum motor so that they are activated at the same time. In other embodiments, the driller and the vacuum module may be equipped with a wireless communication system that causes the vacuum to be activated when the driller motor is activated. A bottom-up view of an installed vacuum module in accordance with an embodiment is illustrated in FIG. 12. Vacuum module 120 can be seamlessly integrated into the drilling robot using an installation platform 121 and securely fastened using mounting clips 122, which provide a stable base for the vacuum module while allowing for easy maintenance and cleaning. In certain embodiments, as shown in FIG. 1, the vacuum module 120 is coupled to the robot chassis 140 so that a top surface of the vacuum module is lower than a navigation beacon so as to not interfere with the line of sight of the navigation beacon.

Additionally, dust collector heads may be integrated into the drilling guide jig such that the dust collector heads can move up and down in conjunction with the drill bit during drilling. Dust collector heads can cover the drilled holes precisely during operation to capture dust and debris as they are produced. By closely following the motion of the drill bit, dust collector heads provide thorough suction from the source, maintaining a clean working environment and preventing any potential inaccuracies or malfunctions caused by the accumulation of dust and debris.

As an example, when a drilling robot reaches the target position for a task, the ECU cause energization of the lead screw motor, causing downward movement of the driller and the drilling guide jig until the drill bit makes contact with the work surface. The ECU may monitor the encoder on the lead screw motor and, when it senses that the current drawn by the actuator motor exceeds a current threshold, it determines that the drill bit is in full engagement with the work surface. Upon making this determination, the ECU can cause energization of the driller motor to begin drilling a hole in the work surface and the vacuum motor to cause dust to be collected while drilling. In several embodiments, ECUs may activate the vacuum motor before powering driller motor to start drilling in order to allow for startup of the vacuum before drilling begins. In other embodiments, the vacuum motor and the driller motor may be started substantially simultaneously or the driller motor may be started first. While the driller motor is causing the drill bit to form a hole in the work surface, the ECU can continue to control the lead screw motor to move the driller downward until a desired hole depth is reached; although in some embodiments, lead screw motors may hold the driller at a fixed axial location for a period of time as the drilling operation is performed. Once drilling to a desired depth is complete, the ECU can control the lead screw motor in an opposite direction to return the driller to an upmost position. During the ascent, the ECU may continuously monitor the driller's vertical position. When the ECU detects that the drill bit has exited the hole, the ECU may simultaneously deactivate both the vacuum module and the driller to stop the drill bit's rotation, and halt the vacuum module's dust collection, providing for a seamless coordination and an efficient operation between the driller and the vacuum module. The lead screw motor, driller motor, and vacuum motor may be powered by a single battery and/or power supply that also powers the robot or may be powered by one or more separate batteries or power supplies.

Although specific methods of downward drilling are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A drilling robot comprising:
an outer casing;
a chassis coupled to the outer casing;
a set of one or more motors placed in the chassis configured to drive the robot;
a drilling module; and
a programmable control unit comprising a set of one or more processors and a memory containing a drilling application, wherein execution of the drilling application configures the set of processors to control the drilling robot to:
transmit information associated with the drilling robot to a robot management system;
receive information associated with a drilling task;
perform the drilling task; and
verify completion of the drilling task.

2. The drilling robot of claim 1, wherein the drilling module comprises a drill housing, a drill motor, a drill transmission configured to be driven by the drill motor, a drill chuck, and a drill bit configured to be locked within the drill chuck.

3. The drilling robot of claim 2, wherein the drill transmission transmits a rotational motion to the drill chuck.

4. The drilling robot of claim 1, wherein the drilling module comprises a linear guide rail coupled to the outer casing, wherein the linear guide rail comprises a first slider mounted to the linear guide rail configured to facilitate movements of the drilling module.

5. The drilling robot of claim 4, wherein the drilling module further comprises a second slider mounted to the linear guide rail.

6. The drilling robot of claim 1, wherein the drilling module further comprises at least one shock absorption module that dampens movements of the drill module.

7. The drilling robot of claim 6, wherein the at least one shock absorption module comprises a floating block, a guiding block, and at least one spring.

8. The drilling robot of claim 1, wherein the drilling robot further comprises a lead screw actuator configured to move the drilling module along a movement axis of the drilling module.

9. The drilling robot of claim 8, wherein the lead screw actuator comprises a motor with an encoder, a trapezoidal lead screw, a coupling module, and a calibration sensor.

10. The drilling robot of claim 9, wherein the motor with the encoder applies a rotational movement to the trapezoidal lead screw causing the trapezoidal lead screw to apply a vertical movement to the drilling module.

11. The drilling robot of claim 10, wherein the encoder is configured to measure the rotational movement applied to the trapezoidal lead screw, and the programmable control unit is further configured by the application to monitor the vertical movement to the drilling module based upon the measured rotational movement.

12. The drilling robot of claim 9, wherein the calibration sensor determines if the drilling module is in a safe position for drill bit replacement.

13. The drilling robot of claim 9, further comprising a dust cover to prevent dust from entering the lead screw actuator during drilling.

14. The drilling robot of claim 8, wherein the lead screw actuator is coupled to a slider.

15. The drilling robot of claim 1, further comprising a drilling guide jig that includes an opening to guide a path of a drill bit.

16. The drilling robot of claim 15, wherein the drilling guide jig comprises a die jig supporting a die core, where in the die core provides the opening to guide the path of the drill bit.

17. The drilling robot of claim 1, further comprising a vacuuming module coupled to the outer casing and configured to vacuum debris caused by the drilling module during drilling.

18. The drilling robot of claim 17, wherein the vacuuming module comprises a dust collector head, a vacuum hose port, and a dust inlet.

19. The drilling robot of claim 1, further comprising a sensor configured to detect an ID tag associated with a drill bit to determine if the drill bit is correct for the received task.

20. The drilling robot of claim 1, further comprising an inspection camera mounted near the drilling module to monitor a status of drilling.
